(19) United States
(12) Patent Application Publication
(10) Pub. No.: US 2008/0024325 A1
(43) Pub. Date: Jan. 31, 2008

(54) Technique applicable to detecting vehicles

(75) Inventors: Kenji Kobayashi, Oobu-shi (JP); Hiroaki Kumon, Oobu-shi (JP); Yukimasa Tamatsu, Okazaki-shi (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/879,624

(22) Filed: Jul. 18, 2007

(30) Foreign Application Priority Data
Jul. 28, 2006 (JP) 2006-206899

(51) Int. Cl. G08G 1/01

(52) U.S. Cl. 340/939

(57) ABSTRACT

A vehicle detection system can reduce erroneous detection of light spots originated from vehicle tail lamps as being those originated from disturbing light sources, such as reflectors on the roadside, in the image data picked up by an image pickup means, such as a camera. Where light spots, or bright areas, originated from some light sources are present in the image data, detection is performed as to whether or not the light spots are a row of light spots originated from reflectors, referring to the location of a partition line defining the lane where the instant vehicle travels. If the light spots are regarded as being the row of light spots originated from the reflectors, these light spots are deleted from the objects to be detected in performing detection of the light spots originated from other vehicle lamps.

### CROSS-REFERENCE TO RELATED APPLICATION

This application is based on and claims the benefit of priority from earlier Japanese Patent Application No. 2006-206899 filed Jul. 28, 2006, the description of which is incorporated herein by reference.

### BACKGROUND OF THE INVENTION

1. Technical Field of the Invention

The present invention relates to a vehicle detection technique, in particular, the technique is applicable to detecting vehicles and is able to detect vehicles such as a preceding vehicle and an oncoming vehicle at night by using an image sensor.

2. Related Art

Japanese Patent Laid-Open No. 6-276524, for example, discloses an oncoming vehicle recognition system. In this system, an oncoming vehicle is recognized from an image in which a plurality of lights, such as headlamps of an oncoming vehicle and street lamps, are mixedly shown. This system operates in such a way that a TV camera picks up an image, an oncoming vehicle recognition area is set in the picked-up image, the image within the set area is binarized and noises are removed therefrom, bright areas obtained by the binarization are labeled, and the center of gravity and dimensions of each of the labeled bright areas are calculated. Subsequently, a pair of bright areas which are assumed to be the head lamps of the oncoming vehicle are determined as being candidate lights. Where a bright area is present below these candidate lights, the system recognizes the candidate lights as being the head lamps of the oncoming vehicle. A distance to this oncoming vehicle from the instant vehicle is calculated based on the length between the candidate lights of the recognized oncoming vehicle.

The oncoming vehicle recognition system disclosed in Japanese Patent Laid-Open No. 6-276524 recognizes an oncoming vehicle by utilizing not only simply the fact that the candidate lights are paired, but also the fact that, if the candidate lights are actually produced by the headlamps, road-surface reflection is caused. Thus, this system is adapted to more reliably recognize an oncoming vehicle from a picked-up image in which a plurality of light spots originated from the street lamps or the reflection from the nearby buildings are also mixedly formed.

However, a large distance between the oncoming vehicle and the instant vehicle may influence on an image picked up by the camera. Particularly, in an image picked up in this large-distance condition, the bright areas to be paired may appear on the picked-up image as a single bright area without being separated from each other, to which the bright area of the road-surface reflection may also be coupled to produce a larger single bright area. Under such circumstances, the system disclosed in Japanese Patent Laid-Open No. 6-276524 may raise a problem that the headlamps of the oncoming vehicle may not be distinguished from disturbing light sources, such as reflectors provided on the roadsides.

### SUMMARY OF THE INVENTION

The present invention has been made in light of the problem mentioned above and has as its object to provide a vehicle detection method, program product and system which can reduce erroneous detection of noise, i.e., the light spots produced by the disturbing light sources, such as reflectors, as being signal, i.e., the light spots produced by the light sources of vehicle lamps in an image data picked up by an image pickup means, such as a camera.

In order to achieve the above object, the method for detecting a spot of light generated from a lamp of other vehicles other than an instant vehicle, the method comprising: imaging a forward view of the instant vehicle and outputting a first image data of the view; detecting, from the first image data, a second image data indicating a line on a road, the line running along the road on which the instant vehicle and the other vehicles are present; filtering the first image data to remove therefrom a noise consisting of image data other than the spot of light; and outputting a signal filtered by the filter, the a signal indicating the spot of light.

The program product for detecting a spot of light generated from a lamp of other vehicles other than an instant vehicle, a program of the program product comprising the steps of: imaging a forward view of the instant vehicle and outputting a first image data of the view; detecting, from the first image data, a second image data indicating a line on a road, the line running along the road on which the instant vehicle and the other vehicles are present; filtering the first image data to remove therefrom a noise consisting of image data other than the spot of light; and outputting a signal filtered by the filter, the a signal indicating the spot of light.

A system for detecting a spot of light generated from a lamp of other vehicles other than an instant vehicle equipping the system, the system comprising: an imaging device imaging a forward view of the instant vehicle and outputting a first image data of the view; a detector detecting, from the first image data, a second image data indicating a line on a road, the line running along the road on which the instant vehicle and the other vehicles are present; a filter filtering the first image data to remove therefrom a noise consisting of image data other than the spot of light; and an output member outputting a signal filtered by the filter, the a signal indicating the spot of light.

### BRIEF DESCRIPTION OF THE DRAWINGS

In the accompanying drawings:

FIG. 1 is a schematic diagram illustrating a configuration of a headlight control system using a vehicle detection system according to a first embodiment of the present invention;

FIG. 2 is a schematic diagram illustrating an internal configuration of a vehicle detection system in the present embodiments with peripherals thereof;

FIG. 3 is a flow diagram illustrating vehicle detection processes performed by a vehicle detection system;

FIG. 4 is an explanatory diagram illustrating a forward view of an instant vehicle, this view being used in a white line detection process in the vehicle detection processes;

FIG. 5A is an explanatory diagram illustrating a forward view of an instant vehicle, this view being used in a reflector detection process in the vehicle detection processes;

FIG. 5B is another explanatory diagram illustrating a forward view of an instant vehicle, this view being used in a reflector detection process in the vehicle detection processes;

FIG. 6A is a flow diagram illustrating vehicle detection processes performed by a vehicle detection system according to a second embodiment of the present invention;

FIG. 6B is a local process flow diagram performed in a step for setting no-vehicle area shown in FIG. 6A according to a modified second embodiment of the present invention; and

FIG. 7 is an explanatory diagram illustrating a forward view of an instant vehicle with a no-vehicle area and a vehicle-present area according to the second embodiment.

### DETAILED DESCRIPTION OF THE PREFERRED EMBODIMENTS

### First Embodiment

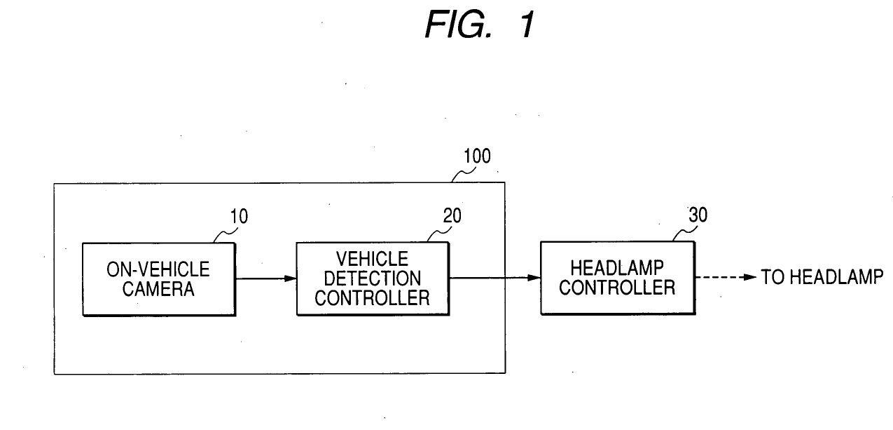

Hereinafter is described a first embodiment of the present invention with reference to the accompanying drawings. FIG. 1 is a schematic diagram illustrating a configuration of a headlight system using a vehicle detection system according to the present embodiment.

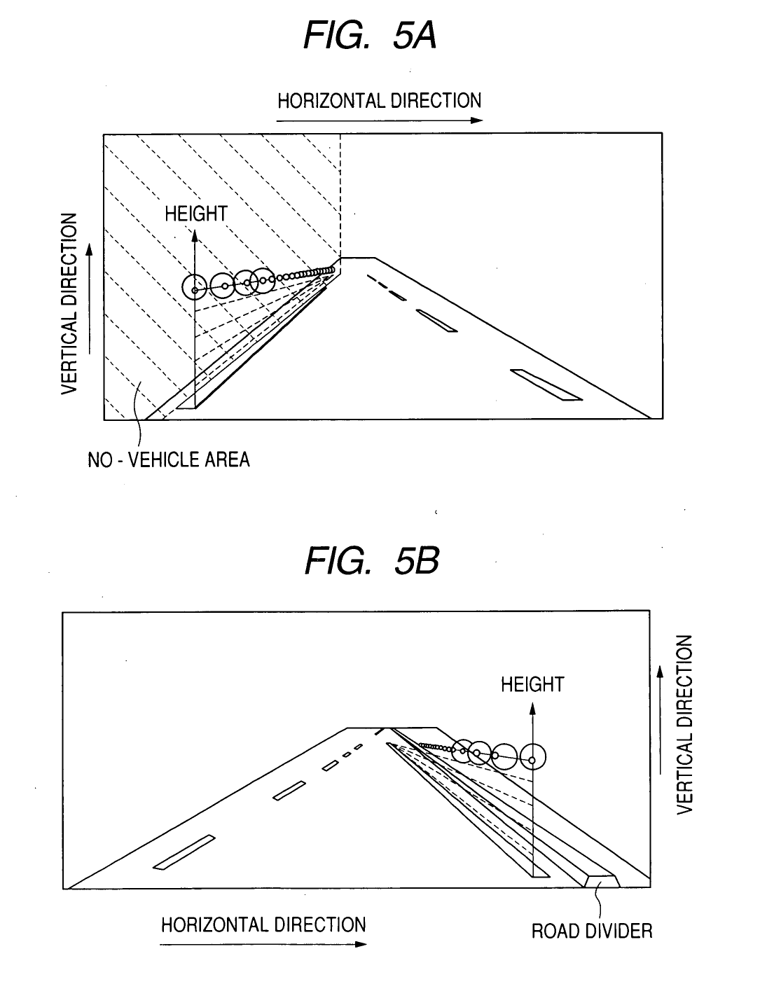

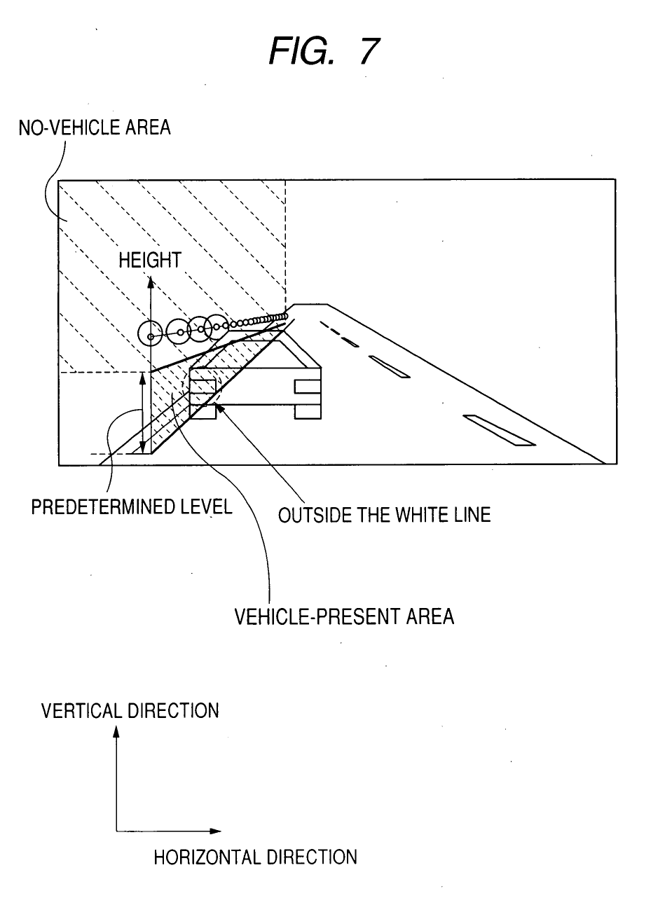

In FIG. 1, an on-vehicle camera (hereinafter is referred to just as a “camera”) 10 is incorporated with an image sensor having a light-receiving element, such as a charge coupled device (CCD). The camera 10 is loaded on an instant vehicle so that images of a forward direction of the instant vehicle can be taken. In particular, the camera 10 is fixedly set in the instant vehicle so that the direction for taking images matches a predetermined reference direction (e.g., vertical and horizontal direction shown in FIGS. 5A, 5B and 7).

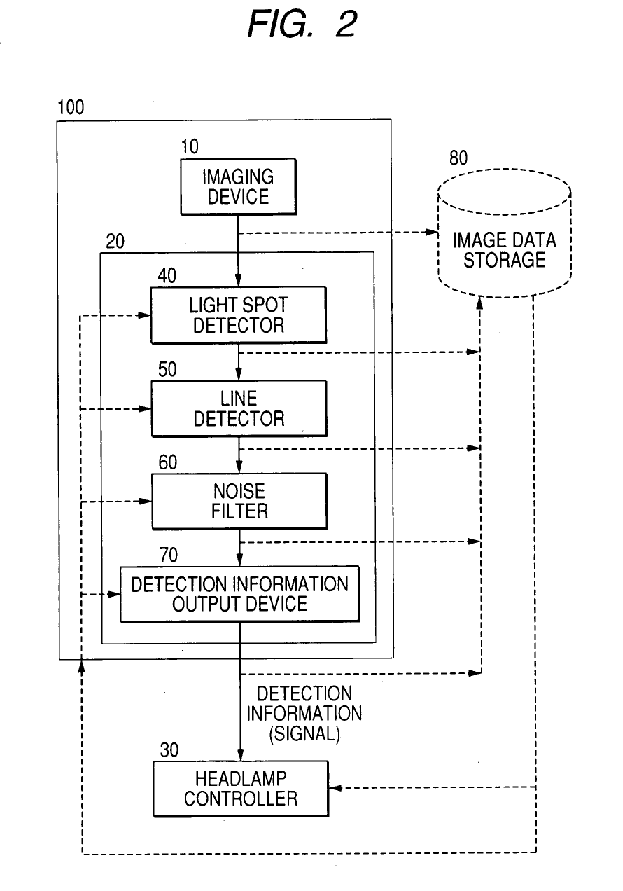

The camera 10 is configured in such a way that it can adjust a shutter speed, a frame rate, a gain of a digital signal outputted to a vehicle detection controller 20, or the like under the control of a control unit, not shown, incorporated in the camera. The camera 10 outputs digital signals that serve as image data indicating the brightness of individual pixels of a picked-up image. These digital signals, together with horizontal/vertical synchronizing signals, are outputted to the vehicle detection controller 20. (Details of the vehicle detection controller is shown in FIG. 2.)

The vehicle detection controller 20 applies image processing to the image data inputted from the camera 10 to detect light spots originated from the tail lamps of a preceding vehicle or the headlamps of an oncoming vehicle. When such light spots originated from the tail lamps of a preceding vehicle or the headlamps of an oncoming vehicle are detected, the detection information on the preceding or oncoming vehicle is outputted to a headlamp controller 30.

The headlamp controller 30 then controls a beam-axis alignment, i.e., an orientation of the headlamps based on the detection information on other vehicles, such as a preceding vehicle and an oncoming vehicle, inputted by the vehicle detection controller 20. For example, where a distance from the instant vehicle to a preceding or oncoming vehicle provided by the detection information is equal to or less than a predetermined distance, the orientation of the headlamps is controlled to emit low beams of light. Thus, a driver of the preceding or oncoming vehicle is prevented from being dazzled by the headlamps of the instant vehicle. On the other hand, where the distance from the instant vehicle to the preceding or oncoming vehicle is equal to or more than the predetermined distance, or where no preceding or oncoming vehicle is detected, the orientation of the headlamps is controlled to emit high beams of light so as to assure high visibility for the driver of the instant vehicle. Use of the image data of the camera 10 enables detection of a preceding or oncoming vehicle which is relatively far away (e.g., 600 m) from the instant vehicle, so that the headlamp controller 30 can adequately control the orientation of the headlamps.

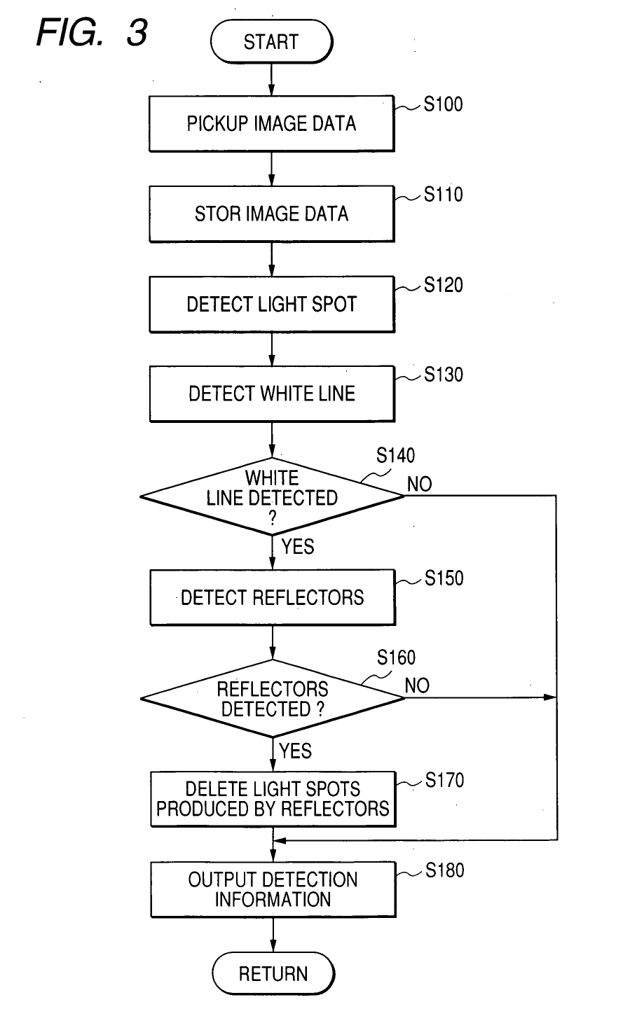

The procedure of vehicle detection in the vehicle detection system 100 will now be described in detail below with reference to a flow diagram of FIG. 3.

At step S100, the image data picked up by the camera 10, functioning as an imaging device 10 shown in FIG. 2, along a forward direction of the instant vehicle. At step S110, the image data is stored in a memory (e.g., a image data storage 80 shown in FIG. 2) first. As mentioned above, the image data includes signals indicative of the brightness of the individual pixels. At step S120, functioning as a light spot detector 60 shown in FIG. 2, light spots having high brightness, which are assumed to be the light sources, are detected from the image data stored in the memory.

Specifically, the brightness of each individual pixel is compared with a predetermined threshold brightness to carry out binarization processing. In the binarization processing, a pixel having brightness equal to or more than the predetermined threshold brightness is allocated with “1” and a pixel having brightness less than the predetermined threshold brightness is allocated with “0” to thereby produce a binarized image. Subsequently, if the pixels allocated with “1” are close to each other in the binarized image, labeling processing is carried out. In the labeling processing, these pixels are labeled so as to be recognized as being a single light spot. In this way, a light spot made up of a collection of a plurality of pixels is detected as a single light spot.

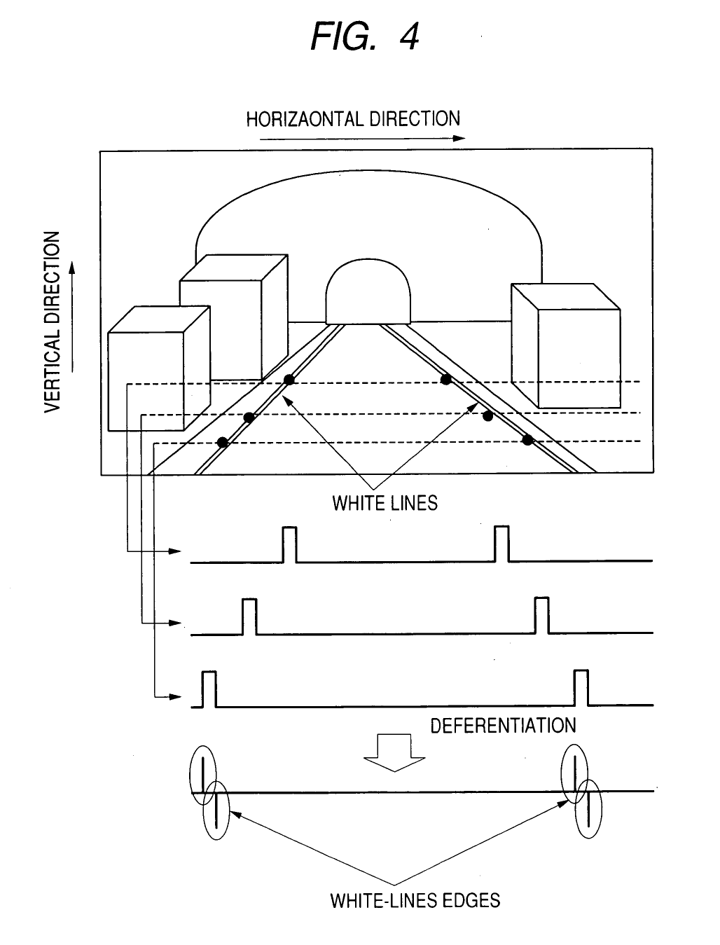

At step S130, functioning as a line detector 50 shown in FIG. 2, arithmetic processing is carried out in respect of the image data stored in the memory to detect positions of the white lines. Usually, the white lines serve as partition lines defining the lanes of the road where vehicles travel or are present. To this end, a white-line area containing the white lines in the image picked up by the camera is determined in advance based, for example, on the orientation and angle of view of the camera 10. Then, as shown in FIG. 4, for example, differentiation processing is applied to the image data in the white-line area to extract edges where the brightness significantly changes.

In this case, where the headlamps of the instant vehicle are being turned on, the light emitted from the headlamps is reflected by the white lines. As a result, the white lines are shown comparatively brightly in the image data. Thus, such an edge can be detected at a position turning from a road region (dark area) to a white-line region (bright area) or at a position turning from the white-line region (bright area) to the road region (dark area). In this way, when the combination of the detected edges forms a shape corresponding to a white line, a white line is detected as lying at the position of the combined edges.

It should be appreciated that the white-line detection processing is not limited to the one described above, but may be carried out by using other known processes. For example, the brightness of the pixels corresponding to the white-line region is higher than that of the pixels corresponding to the road region as described above. Based on this, a threshold may be set, and then the pixels having brightness equal to or more than the set threshold brightness may be extracted. When a shape corresponding to a white line has appeared by combining the extracted pixels, the collection of the extracted pixels may be detected as a white line. The colors of partition lines include yellow other than white. It should be appreciated that the white-line detection processing described above may also be applied to the detection of the yellow partition lines, furthermore, a line on and along the road where the instant vehicle runs or is present.

In the white-line detection processing at step S130, no white line may be detected in the absence of the white lines on the rode, for example. At the subsequent step S140, functioning as a noise filter 60 shown in FIG. 2 together with a proper combination of S150, S160 and S170 according to a filtering target, therefore it is determined whether or not a white line has been detected. If no white line is determined as having been detected at step S140, the procedure proceeds to the processing at step S180, functioning as a detection information output device 70 (also referred to as “an output member”) shown in FIG. 2. If, on the other hand, a white line is determined as having been detected at step S140, the procedure proceeds to the processing at step S150.

At step S150, reflector detection processing is carried out, in which the light spots originated from the reflectors provided along the roadside are detected.

In the daytime, a vehicle driver can drive the vehicle by using the white lines and the guard fences, for example, as traveling guides. At night, however, it is significantly difficult to catch sight of these facilities serving as the traveling guides. The road geometry therefore can only be visually recognized chiefly in a limited range illuminated by the headlamps of the instant vehicle. Thus, for the improvement, for example, of the degree of recognition of the road geometry, reflectors (also referred to as “delineators”) having very high reflectance may be set up along the roadside. The provision of such reflectors along the roadside may allow the vehicle driver, if the headlamps of the driver's vehicle are on, to recognize the reflectors over a long distance.

On the other hand, however, such high-reflectance reflectors may appear on the image data picked up by the camera 10 with the brightness equivalent to the light spots produced by some light sources. Therefore, the light spots produced by the reflectors may be erroneously detected as other vehicle lamps, such as the tail lamps of a preceding vehicle or the headlamps of an oncoming vehicle. To take measures for this, the present embodiment detects the light spots of the reflectors referring to the positions of the white lines. Accordingly, the light spots produced by the reflectors can be excluded in advance from the detection of vehicle lamps to thereby reduce as much as possible the erroneous detection mentioned above.

Hereinafter, a scheme of detecting the light spots originated from the reflectors is described with reference to FIG. 5A. The reflectors are set up along the roadside with a certain interval therebetween. As shown in FIG. 5A, when such reflectors are provided on the roadside, the image data shows a row of a plurality of light spots, which extends parallel to the white line as the partition line. That is, actually, the row of the plurality of light spots extending parallel to the white line. However, in the picked-up image, this parallel is perspectively modified. In other words, distances (or length) between the light spots and the white line that are far away from the incident vehicle are shorter than those distances that are nearer the incident vehicle. By detecting such a row of the light spots in the image data, the light spots produced by the reflectors can be detected. (A vertical and horizontal direction in the image data are defined as shown in FIG. 5A, also shown in FIGS. 4 5B and 7.)

As shown by broken lines in the specific example of detecting the row of the light spots in FIG. 5A, the level (i.e., the position in a vertical direction) of the white line detected at step S130 is parallelly shifted stepwise by a predetermined length (corresponding to a height of the reflector) in the direction of height of the reflectors. (This shifting stepwise procedure is achieved for the purpose of absorbing perspective deviations in the image data from the parallelism between the line and reflectors in the actual world.) When the shifted white-line is overlapped by a predetermined number (e.g., four) or more of the light spots, these overlapping plural light spots are detected as a row of the light spots originated from the reflectors.

At subsequent step S160, a determination is made as to whether or not a row of the light spots corresponding to the reflectors has been detected in the reflector detection processing at step S150. At step S160, if it is determined that no row of the light spots corresponding to the reflectors has been detected, control proceeds to step S180. Contrarily, if a row of the light spots corresponding to the reflectors has been determined as having been detected at step S160, control proceeds to step S170.

At step S170, the row of the light spots corresponding to the reflectors is deleted from the image data. Thus, the light spots remaining in the image data no longer include the light spots produced by the reflectors. As a result, accurate detection can be performed of the light spots originated from the vehicle light sources, such as the tail lamps of a preceding vehicle or the headlamps of an oncoming vehicle.

At step S180, the light spots originated from the tail lamps of the preceding vehicle or the light spots originated from the headlamps of the oncoming vehicle are detected from among the light spots included in the image data based, for example, on the brightness, shapes and symmetricalness of the light spots. Where the light spots produced by the tail lamps of the preceding vehicle or the headlamps of the oncoming vehicle are detected, vehicle detection information is outputted to the headlamp controller 30, indicating that other vehicles, such as the preceding and oncoming vehicles, have been detected. Preferably, the vehicle detection information may include a distance to each of the detected vehicles. As is well known, a distance to a detected vehicle can be calculated based, for example, on a length between the left and right lamps, and the positions of the light spots in the image sensor.

At step S140, if it is determined that no white line has been detected, and at step S160, if it is determined that no reflector has been detected, control proceeds to step S180 without carrying out the process of step S170. Accordingly, in this case, all the light spots detected at step S120 are subjected to the processing for detecting the light spots originated from other vehicle lamps.

FIG. 5A shows an example of detecting a row of the light spots produced by the reflectors based on the left-side white line. However, as shown in FIG. 5B, when the road where the instant vehicle runs or is present is divided by a road divider from the oncoming lanes, for example, the reflectors may be set up along the right-side white line. Thus, as well as the detection based on the left-side white line, the light spots produced by the reflectors may be detected based on the right-side white line.

Note that the vehicle detection procedure S110 to S180 explained above and shown in FIG. 2 can be realized in both a program manner and an electrical circuit manner. And the image data including various image information necessary to be processed in each process (one of S120 to S180 in FIG. 2) or device (one of 40 to 70 shown in FIG. 2) can be not also fed to next process or a device via the image data storage 80 but also directly fed thereto from previous procedure as an output therefrom.

Advantages of this first embodiment now will be described hereinafter using the vehicle detection system. Identical advantages to the system can be achieved in a method or a program product manner to which identical technique are applied and recited in attached claims.

The vehicle detection system 100 described in this embodiment comprises: an imaging device (10, 40; S100, S120) imaging a forward view of the instant vehicle and outputting a first image data of the view; a detector (50; S130) detecting, from the first image data, a second image data indicating a line on a road, the line running along the road on which the instant vehicle and the other vehicles are present; a filter (60; S140,S150, S160 and S170) filtering the first image data to remove therefrom a noise consisting of image data other than the spot of light; and an output member (70; S180) outputting a signal filtered by the filter, the a signal indicating the spot of light.

Thus, in the vehicle detection system of the present embodiment, the light spots, or bright areas, produced by some light sources and appear on the image data are detected as to whether or not the light spots have been produced by the disturbing light sources, with reference to the location of the partition lines. If the light spots are considered as being originated from the disturbing light sources, such light spots are deleted from the objects to be detected in detecting the light spots originated from other vehicle lamps as light sources. As a result, erroneous detection of the light spots originated from the disturbing light sources, such as the reflectors set up on the roadside as being the light spots originated from vehicle lamps can be reduced as much as possible.

In this system 100 just described above, particularly, the filter (60; S140,S150, S160 and S170) filters a third image data originated from a plurality of light spots extending parallel to the line. Further particularly, the plurality of light spots are produced by reflectors provided on a side of the road.

The reflectors set up along the roadside, which are also referred to as “delineators”, have very high reflectance. When the headlamps of the instant vehicle are being turned on, the light reflected by the reflectors is picked up by the image pickup means and appears on the image data with the brightness corresponding to the light spots produced by some light sources. For the improvement of the degree of recognition of the road geometry at night, the reflectors, with a certain same height, are set up along the roadside with a certain interval therebetween. Accordingly, the reflectors set up along the roadside appear on the image data as a row of a plurality of light spots extending parallel to the partition line. In this particular system, detection of the row of the light spots can enable deletion of the light spots produced by the reflectors in detecting light spots produced by vehicle lamps.

Further, A specific scheme for detecting the row of the light spots can be presented. In this system 100 just described above, preferably, the filter 60 filters the third image data when the third image data overlaps to the second image data by shifting stepwise to a direction. Particularly, the direction is a direction indicating height of a reflector provided along the line in the first image data.

In this way, recognition error originated from the reflectors can be reduced, thus, increasing the ability to remove noise.

### Second Embodiment

A second embodiment of the present invention is described below. The vehicle detection system according to the second embodiment has a configuration similar to the one in the first embodiment. In the second embodiment, the identical or similar components or processes to those in the first embodiment are given the same reference numerals for the sake of simplifying or omitting the explanation.

A difference of the vehicle detection system of the present embodiment from that of the first embodiment resides in the scheme of detecting the disturbing light sources, such as the reflectors. The description below is focused on the scheme of detecting the disturbing light sources, such as the reflectors, in the vehicle detection system according to the second embodiment.

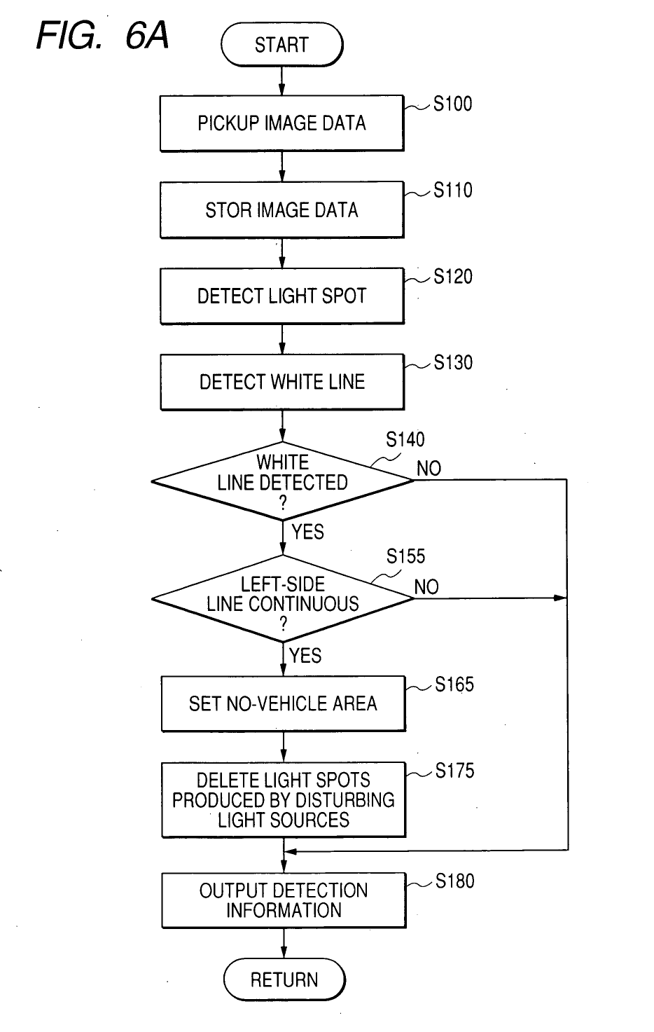

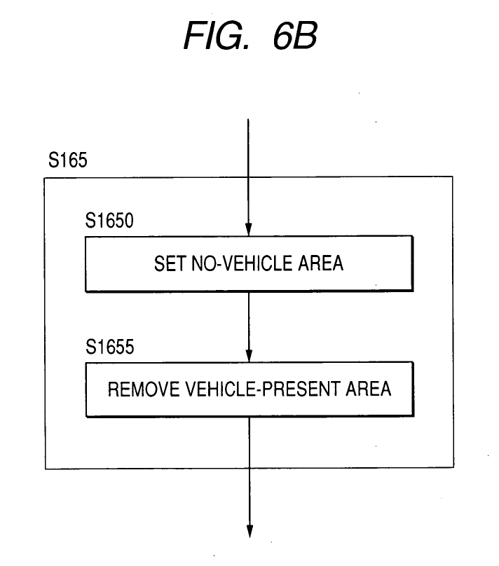

FIG. 6A is a flow diagram illustrating vehicle a detection processes in detail performed by a vehicle detection system 100 according to the present embodiment. In the flow diagram illustrated in FIG. 6A, from step S110 for storing an image data to step S140 for determining the white line detection as well as step S180 for outputting the vehicle information are the same as those illustrated in the flow diagram of FIG. 3.

In the present embodiment, if the white line is determined as having been detected at step S140, control proceeds to step S155, functioning as a noise filter 60 shown in FIG. 2 together with S140, S165 and S175, where it is determined whether or not the left-side white line is continuous.

The road region where the instant vehicle as well as other vehicles such as the preceding and oncoming vehicles travels is basically divided into lanes by partition lines, such as white lines. For a plurality of lanes provided for the same traveling direction, broken lines are used to define each of the plurality of lanes, and for a border dividing between the road region and the region outside the road region, a continuous line is used. Thus, with respect to the preceding vehicle that travels on a lane toward a traveling direction in which the instant vehicle travels, the partition line that lies opposite to the oncoming lane can be used as a basis for determining a no-vehicle area where no preceding vehicle is present. Specifically, when the left-side white line of a lane where the instant vehicle travels in left-hand traffic is a continuous line, the lane can be regarded as being the leftmost lane. Accordingly, the outside of the leftmost white line along the lane where the instant vehicle travels can be regarded as being the no-vehicle area, such as a side strip, where no preceding vehicle is present.

Therefore, when a determination “YES” is made at step S155, control proceeds to step S165 where the left-side white line is used as a basis for setting an area left-side of the white line (outside the lane) as the no-vehicle area where no preceding vehicle travels. At the subsequent step S175 the light spots belonging to the no-vehicle area set at step S165 are regarded as being produced by the disturbing light sources, such as the reflectors, and deleted from the image data. Thus, the light spots remaining in the image data no longer contain those light spots originated from the disturbing light sources, such as the reflectors, whereby accurate detection can be performed for the light spots originated from other vehicle lamps.

As shown in FIG. 7, however, in spite of the fact that the preceding vehicle travels inside the leftmost partition line that is the road border, the tail lamps of the preceding vehicle, which are located at a certain level, may appear on the image data as if being present outside the leftmost partition line. This is because, on the image data, a closer-range object appears with a larger dimension, and a longer-range object appears with a smaller dimension, as in so-called linear perspective, and thus because the partition line, as it extends farther, appears as an oblique line extending closer to the center of the image.

In setting the no-vehicle area at step S165, it is preferable that, as shown in FIG. 7, an area below a predetermined level (length) down to the left-side continuous partition line (leftmost partition line) is fixed as a vehicle-present area in the image data, and that an area above the predetermined level is fixed as the no-vehicle area. In other words, in this case, the no-vehicle area is set, excluding in advance, the vehicle-present area. Alternately, as shown in FIG. 6B, step 165 can have two sub-steps, namely, step S1650 of setting no-vehicle area and step S1655 of removing vehicle-present area from this no-vehicle area. In this way, it is possible to prevent deletion of the light spots produced by the tail lamps of the preceding vehicle that travels inside the leftmost partition line by erroneously recognizing them as being produced by the disturbing light sources.

Note that the vehicle detection procedure S110 to S180 explained above and shown in FIG. 2 can also be realized in both a program manner and an electrical circuit manner. And various image information necessary to be processed in each process (one of S120 to S180 in FIG. 6A, S1650 and S1655 in FIG. 6B) or device (one of 40 to 70 shown in FIG. 2) can be not also fed to next process or a device via the image data storage 80 but also directly fed thereto from a previous procedure as an output therefrom.

Advantages of the second embodiment now will be described hereinafter using the vehicle detection system 100. Identical advantages to the system can be achieved in a method or a program product manner as recited in appended claims.

The vehicle detection system 100 described in the second embodiment, the noise filter (S165; S1650) filters all of image data within a no-vehicle area in the first image data, the no-vehicle area defined based on the second image data.

A road, or a road area, where other vehicles such as preceding and oncoming vehicles travel is basically defined by partition lines. Thus, by defining the no-vehicle area where no vehicle is present, the light spots included in the no-vehicle area may be regarded as being the light spots originated from the disturbing light sources.

In defining the no-vehicle area using the line on and along the road, it is preferable that the no-vehicle area (shown in FIG. 4A) is defined as an area locating on further opposite side than one of the second image data locating on most opposite side to a side indicating an oncoming lane side in the first image data. Further preferably, the line is continuous.

In case where a plurality of lanes are provided on the road, each partition line defining the lanes is indicated by a broken line. Meanwhile, a partition line which lies on a side opposite to an oncoming lane and partitions between a lane and an area other than the lane (e.g., a side strip) is indicated by a continuous line. Therefore, if the partition line which lies along the lane where the instant vehicle travels, being opposite to an oncoming lane, is a continuous line, the area outside the lane along this partition line can be determined as being the no-vehicle area.

However, in spite of the fact that the preceding vehicle travels inside the partition line, the tail lamps of the preceding vehicles, which are positioned at a certain level, may appear on the image data as if being present outside the partition line. This is because, on the image data, a closer-range object appears with a larger dimension, and a longer-range object appears with a smaller dimension, as in so-called linear perspective, and thus because the partition line, as it extends farther, appears as an oblique line extending closer to the center of the image.

Therefore, it is preferable that the no-vehicle area (i.e., the area defined as the region with broken oblique lines in FIG. 5A) is removed a vehicle-present area (i.e., the area shown as broken oblique lines shown in FIG. 7) defined based on the second image data. Further preferably, the vehicle-present area is defined as an area, in the first image data, indicating a region higher than the line and lower than a level higher than the line by a predetermined length. Alternatively, the no-vehicle area is defined as the area higher than the continuous line by the predetermined level in the forward view of the instant vehicle, this no-vehicle area defined as the region with broken oblique lines shown as area in FIG. 7.

Thus, the light spots produced by the tail lamps of the preceding vehicle can be prevented from being erroneously detected as being the light spots produced by the disturbing light sources.

Further, the method using information of the vehicle-present area can provide easier countermeasures against unexpected errors occurred under various conditions encountering in future, when an area-information of the vehicle-present area is set as a programmable one.

Some preferred embodiments of the present invention have been described above. The present invention, however, should not be limited to the embodiments described above but may be embodied with various modifications within a scope not departing from the spirit of the present invention.

For example, the vehicle detection system in the above embodiments has been applied to the headlamp controller. However, the vehicle detection system may be applied to a drive assist system, for example, which detects a preceding or oncoming vehicle at night to give an indication or warning to the driver accordingly.

Further, above embodiments are described, supposing the case of left-hand traffic in Japan. In case of right-hand traffic, e.g., in US and Germany, although, the vehicle detection schema disclosed in this description is also applicable when left and right-side are switched with appropriate modifications complying with each rule of the road in these countries.

What is claimed is:

1. A system for detecting a spot of light generated from a lamp of other vehicles other than an instant vehicle equipping the system, the system comprising:
an imaging device imaging a forward view of the instant vehicle and outputting a first image data of the view;
a detector detecting, from the first image data, a second image data indicating a line on a road, the line running along the road on which the instant vehicle and the other vehicles are present;
a filter filtering the first image data to remove therefrom a noise consisting of image data other than the spot of light; and
an output member outputting a signal filtered by the filter, the a signal indicating the spot of light.

2. The system of claim 1, wherein the filter is configured to filter a third image data originated from a plurality of light spots extending parallel to the line.

3. The system of claim 2, wherein the filter is configured to filter the third image data when the third image data overlaps the second image data by shifting stepwise to a direction.

4. The system of claim 3, wherein the direction is a direction indicating height of a reflector provided along the line in the first image data.

5. The system of claim 1, wherein the filter filters all of image data within a vehicle-absent area in the first image data, the vehicle-absent area defined based on the second image data as being an area where no vehicle is.

6. The system of claim 5, wherein the vehicle-absent area is an area located outside an outermost image included in the second image, the outermost image locating most opposite to an oncoming lane.

7. The system of claim 5, wherein the vehicle-absent area is removed a vehicle-present area defined based on the second image data.

8. The system of claim 7, wherein the vehicle-present area is an area, in the first image data, indicating a region higher than the line and lower than a level higher than the line by a predetermined length.

9. The system of claim 5, wherein the vehicle-absent area is an area higher by the predetermined level than one of the second image data locating on most opposite side to a side indicating an oncoming lane side in the first image data.

10. A method for detecting a spot of light generated from a lamp of other vehicles other than an instant vehicle, the method comprising:
imaging a forward view of the instant vehicle and outputting a first image data of the view;
detecting, from the first image data, a second image data indicating a line on a road, the line running along the road on which the instant vehicle and the other vehicles are present;
filtering the first image data to remove therefrom a noise consisting of image data other than the spot of light; and
outputting a signal filtered by the filter, the a signal indicating the spot of light.

11. The method of claim 10, wherein the filtering step filters a third image data originated from a plurality of light spots extending parallel to the line.

12. The method of claim 11, wherein the filtering step filters the third image data when the third image data overlaps to the second image data by shifting stepwise to a direction.

13. The method of claim 12, wherein the direction is a direction indicating height of a reflector provided along the line in the first image data.

14. The method of claim 10, wherein the filtering step filters all of image data within a vehicle-absent area in the first image data, the vehicle-absent area defined based on the second image data.

15. The method of claim 14, wherein the vehicle-absent area is an area locating on further opposite side than one of the second image data locating on most opposite side to a side indicating an oncoming lane side in the first image data.

16. The method of claim 14, wherein the vehicle-absent area is removed a vehicle-present area defined based on the second image data.

17. The method of claim 16, wherein the vehicle-present area is an area, in the first image data, indicating a higher region than the line by a predetermined length.

18. The method of claim 14, wherein the vehicle-absent area is an area higher by the predetermined level than one of the second image data locating on most opposite side to a side indicating an oncoming lane side in the first image data.

19. A program product for detecting a spot of light generated from a lamp of other vehicles other than an instant vehicle, a program of the program product comprising the steps of:
imaging a forward view of the instant vehicle and outputting a first image data of the view;
detecting, from the first image data, a second image data indicating a line on a road, the line running along the road on which the instant vehicle and the other vehicles are present;
filtering the first image data to remove therefrom a noise consisting of image data other than the spot of light; and
outputting a signal filtered by the filter, the a signal indicating the spot of light.

20. The program product of claim 19, wherein the filtering step filters a third image data originated from a plurality of light spots extending parallel to the line.
